(19) United States
(12) Patent Application Publication
(10) Pub. No.: US 2016/0173501 A1
(43) Pub. Date: Jun. 16, 2016

(54) MANAGING ELECTRONIC ACCOUNT ACCESS CONTROL

(71) Applicant: Wendell Brown, Henderson, NV (US)

(72) Inventor: Wendell Brown, Henderson, NV (US)

(21) Appl. No.: 14/966,994

(22) Filed: Dec. 11, 2015

Related U.S. Application Data
(60) Provisional application No. 62/090,715, filed on Dec. 11, 2014.

(51) Int. Cl. H04L 29/06; G06F 21/62

(52) U.S. Cl. CPC H04L 63/102; G06F 21/6245; H04L 63/083; H04L 63/0861

(57) ABSTRACT

In general, embodiments of the present invention provide systems, methods and computer readable media for controlling access to an electronic account. In some embodiments, a method includes receiving, at a server computer and from an electronic account provider computer, a notification pertaining to an electronic account belonging to a user. The method also includes, sending, via the server computer, an authorization request to the user. The method further includes receiving, a response to the authorization request sent to the user. The method additionally includes authenticating the user based at least in part on the received response to the authorization request. The method also includes granting the user access to the electronic account based at least in part on the authenticating step.

### CROSS-REFERENCE TO RELATED APPLICATIONS

This application claims the benefit of U.S. Provisional Application No. 62/090,715, entitled “METHOD AND APPARATUS OF MANAGING ELECTRONIC ACCOUNT ACCESS CONTROL,” and filed Dec. 11, 2014, the entire contents of which is incorporated herein by reference.

### FIELD

Embodiments of the invention relate, generally, to integrating hardware and software for managing electronic account access control.

### BACKGROUND

Aspects of the disclosure relate to managing electronic account access control. Today, many users access a variety of accounts electronically. Some examples of accounts that can be accessed electronically include, but are not limited to, e-mail accounts, file management accounts, social media accounts, and financial accounts. These electronic accounts may exist in “the cloud,” on corporate or enterprise servers, or locally on computing devices.

Typical current solutions for authenticating users and performing electronic account permission management make use of passwords, security questions (e.g., “Enter your password” or “What was your first pet's name”), and 2-Factor Authentication utilizing push notifications, emails, and SMS as means to authenticate an individual to access an electronic account. However, these types of solutions have proven to be weak and vulnerable to attack by fraudsters. It is commonplace for electronic accounts to be taken over, to be falsely logged into, and to be hacked or hijacked. In many cases, financial or reputational losses are common when hackers gain control of an electronic account.

Thus, current methods for authenticating users and performing electronic account permission management exhibit a plurality of problems that make current systems insufficient, ineffective and/or the like. Through applied effort, ingenuity, and innovation, solutions to improve such methods have been realized and are described in connection with embodiments of the present invention.

### SUMMARY

Certain embodiments are described that provide a solution to reduce the likelihood of unauthorized access to an account, to monitor accounts, and to further control and limit access to an account determined to be the target of unauthorized users. More specifically, certain embodiments disclose securing access to electronic accounts, providing flexible and customized authentication processes, and protecting against false or hacked credentials relating to electronic account access.

In some embodiments, a method includes receiving, at a server computer and from an electronic account provider computer, a notification pertaining to an electronic account belonging to a user. The method also includes sending, via one or more server computers, an authorization request to the user. The method further includes receiving, a response to the authorization request sent to the user. The method additionally includes authenticating the user based at least in part on the received response to the authorization request. The method also includes granting the user access to the electronic account based at least in part on the authenticating step.

Other embodiments of the invention are directed to communication devices, servers, and systems that are configured to perform the above-described methods. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow diagram of an example method whereby an existing electronic account service is integrated with embodiments of the invention by means of an email connection in accordance with some embodiments discussed herein;

FIG. 2 is a flow diagram of an example method whereby a mobile phone is connected to a central server and transmits the location (GPS) of that mobile phone to the central server in accordance with some embodiments discussed herein;

FIG. 3 is a flow diagram of an example method whereby a mobile phone is connected to a central server and transmits the results of a fingerprint scan to the central server in accordance with some embodiments discussed herein; and

FIG. 4 illustrates an example of a computing system in which one or more embodiments may be implemented in accordance with some embodiments discussed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as being limited to the embodiments set forth herein; rather, these embodiments are provided so that this disclosure will satisfy applicable legal requirements. Like numbers refer to like elements throughout.

As described herein, system components can be communicatively coupled to one or more of each other. Though the components are described as being separate or distinct, two or more of the components may be combined into a single process or routine. The component functional descriptions provided herein including separation of responsibility for distinct functions is by way of example. Other groupings or other divisions of functional responsibilities can be made as necessary or in accordance with design preferences.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data may be received directly from the another computing device or may be received indirectly via one or more intermediary computing devices, such as, for example, one or more servers, relays, routers, network access points, base stations, and/or the like. Similarly, where a computing device is described herein to send data to another computing device, the data may be sent directly to the another computing device or may be sent indirectly via one or more intermediary computing devices, such as, for example, one or more servers, relays, routers, network access points, base stations, and/or the like.

As described above, many users access a variety of accounts electronically. These accounts can include, but are not limited to, email accounts (such as Google Gmail, Microsoft Outlook, Yahoo Mail, etc.), file management accounts (such as DropBox, OneDrive, Box, etc.), social media accounts (LinkedIn, Facebook, Twitter, etc.), financial accounts (bank accounts, credit card accounts, stock brokerage accounts, etc.), business-related accounts (such as SalesForce, etc.), hardware management accounts (to control cameras, thermostats, cars, airplanes, space satellites, remote vehicle control, etc.), home security and smart home accounts (such as Nest), game and entertainment related accounts (such as NetFlix, Hulu, Sony Playstation, Steam, Zynga, Electronic Arts online gaming account, Spotify music account, etc.), communications accounts (such as Skype, eFax, GoToMeeting, etc.), travel related accounts (such as Expedia, Orbitz, United Airlines, etc.), retail accounts (such as Amazon, WalMart.com, etc.), manufacturing electronic accounts (such that contain 3-D printer files, chemical plant management accounts, etc.), school or other educational accounts (such as teacher accounts, student accounts, educational materials accounts, etc.), legal related online accounts, food ordering accounts (such as pizzahut.com, etc.), or any other type of electronic account as used by individuals, businesses, or enterprises, governments, or any other entities.

Some of these electronic accounts may exist in “the cloud” (e.g., on servers and databases connected to the internet) or on corporate or enterprise servers, or may exist on any computing device. Some devices may store accounts locally (such as routers, mobile phones, etc.). These devices also may include portable and/or wearable computing devices (such as smart mobile phones, smart watches, smart eyeglasses, tablets, etc.) as well as non-mobile devices (such as desktops, laptops, etc.). In some embodiments, these devices may also include automatic vehicles whereby a user may authenticate with his/her vehicle by interacting with a system within the vehicle.

Embodiments described herein pertain to an integration of hardware and software for managing electronic account access control. In some embodiments, one piece of hardware (such as a mobile phone) executes software and/or firmware. In some embodiments, other hardware (such as servers in the cloud) run varying other pieces of software. In some embodiments, varying other pieces of software control and manage a database and other stored data.

The embodiments described herein provide a number of advantages over existing solutions. These advantages include, but are not limited to: significantly improving the security of and reducing fraudulent access to electronic accounts; enabling a seamless and instant integration method with many existing electronic account providers (without the electronic account provider making any changes to their software); enabling a user to customize the process flow to include a flexible security process; and enabling the transfer of certain processing tasks (such as outbound sending of messages) to be filtered and monitored by the system.

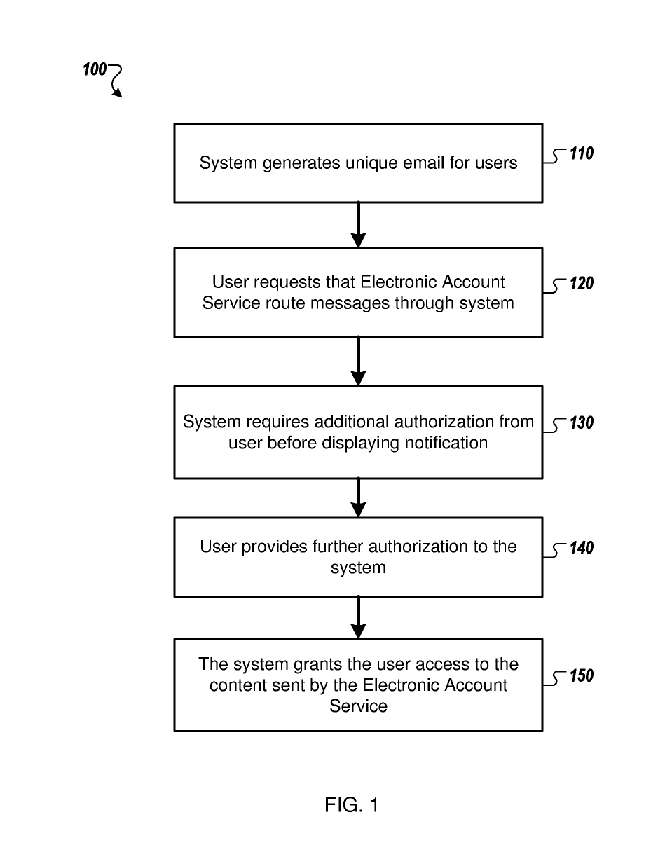

FIG. 1 shows a method whereby an existing electronic account service is integrated with embodiments of the invention by means of an email connection. In block 110, the system may generate a unique e-mail address for the user. That is, the system may provide an incoming e-mail address (or other destination routing address) for each individual user of the system. In some embodiments, a unique e-mail address can be provided for each of the user's individual accounts. The generated e-mail address(es) can be unique to the user (or unique to each of the user's individual accounts).

In block 120, the user may request an electronic account service to route messages through the system. The user may place the request directly with the account service (e.g., DropBox or Facebook). Accordingly, the system may seamlessly integrate with the existing security procedures already implemented by the account service. The system may augment these existing security procedures by means of the user configuring each of his/her existing accounts to route account management changes (such as a password reset approval sent via e-mail) or any other notifications from the account service to the system. In some embodiments, the hardware implementation of the system may reside within a network comprising both the account service and the user's e-mail provider. For example, the system could act as an “intermediary,” within the network, between the account service and the user's e-mail provider. One example of the network could be the Internet. A unique advantage of having the system as an “intermediary” between the account server and the user's e-mail provider is that it provides direct compatibility with many existing electronic account providers, while allowing additional and flexible, user-customizable security processes to be defined and executed.

Additionally, the user may configure the system by customizing his/her own account management procedures (such as when resetting a password). The user may customize these procedures on a user-by-user or account-by-account basis. This is in contrast to existing solutions whereby the electronic account provider determines and provides a fixed process or sequence for different account procedures (such as resetting a password for that account). In some embodiments, the user can self-configure and customize the account access controls to suit his/her particular level and format of account management access and control.

In block 130 the electronic server (e.g., DropBox or Facebook) can send an account notification to the system. The account notification may include data pertinent to the user's individual account.

In block 140, the system may require additional authorization from the user before displaying the received account notification to the user. In some embodiments, the user may provide the additional authorization to the system using an inward bound voice communication channel (VOIP, landline, mobile call, etc.) which voice signals can be carried/sent through, in real-time or in non-real-time. For example, the user may provide the additional authorization using communications via his/her mobile device.

In block 150, the user may provide a response to the system's request for additional authorization. In some embodiments, the user may provide the additional authorization to the system using SMS or TXT messages. For example, the user may respond to or send a new SMS or TXT message from his/her mobile device. In some embodiments, the user may provide the additional authorization to the system by sending an image, a video, or other pictorial image or images. Such images may contain associated information such as a time stamp, geo-location stamp (of where the photograph was taken), a hidden message (steganography), etc. These images or videos may be sent via an application running on the user's mobile device.

In some embodiments, the user may provide the additional authorization to the system by sending a 3-D image information (such as 3-D data of a person's face), for example by the user collecting a 3-D image of his/her own face (which would then be compared against earlier stored “reference” 3-D image information stored within the system, as an approval step. Such 3-D data could be collected by means of a 3-D camera or other sensor. Such 3-D data may also be constructed from individual 2-D images, several 2-D images, or videos.

In some embodiments, the user may provide the additional authorization to the system by sending facial recognition or other bio-recognition information to the system (such as a voiceprint or uniquely identifying thermal image “heat map” of a hand or face).

In some embodiments, the user may provide the additional authorization to the system by sending a signature of a user (for example the user may sign his signature on the touch-screen panel of his/her mobile device or take a picture of his/her signature written on paper). In some embodiments, the user may provide the additional authorization to the system by sending device-specific information (such as a mobile phone hardware identification number, serial number, SIM module number, etc.). It can be appreciated that this information may be sent via an application running on the mobile device.

In some embodiments, the user may provide the additional authorization to the system by sending a password, passcode, or other security token. It can be appreciated that the password may be different than the user's password for the account service. In some embodiments, the security token may be stored within a secure element of the user's mobile device.

In some embodiments, the user may provide the additional authorization to the system by sending a hardware key, IMEI number, serial number, CPU number, chip number, or other hardware-based identification means, of a user-authenticated hardware device. For example, a user's mobile phone IMEI or device ID number may be used to further validate a user. Furthermore, such hardware device ID number may be compared against an on-line database list of reported or suspected lost/stolen hardware devices (such as a police or FBI or manufacturer stolen phone database).

In some embodiments, the user may provide the additional authorization to the system via generated symmetric encryption keys or asymmetric public/private keys used to authenticate a user, whether by sending the keys directly as proof of ownership or possession, signing a message with the user's own private key (e.g., on the mobile device), or decrypting a message with a private key and responding with the decrypted message or some other secret.

In some embodiments, communication to the system may alternatively be performed by communicating directly between devices, such as by Bluetooth, Wi-Fi, a local area network (LAN), or a mesh/relay network.

The account notification sent by the system can be sent for a number of reasons. One non-limiting example is a password change with the account service. In some embodiments, the system may require one or more users to communicate an approval to modify an account item (such as a password), requiring one or more users each (or a minimum of xx out of yy listed possible users) to approve this account change.

In some embodiments, the system may require one or more users to communicate an approval to modify an account item (such as a password), requiring one or more users to each (or a minimum of xx out of yy listed possible users) to approve this account change, and within a time limit (the minimum number of independent approvals must be received within a certain time limit—for example within 30 minutes of the original approval request).

In some embodiments, the system may require one or more users to communicate an approval to modify an account item (such as a password), requiring one or more of a single user's accounts in order to approve this account change, and within a time limit (the minimum number of independent account approvals which must be received within a certain time limit—for example within 30 minutes of the original approval request).

In some embodiments, the system may require one or more users to communicate an approval to modify an account item (such as a password), by means of customizable approval steps, by one or more people, using one or more other electronic accounts, using one or more devices, within one or more geographic locations, or any other combinations of any of the other embodiments described in this invention.

In some embodiments, the system may require one or more users to communicate an approval to modify an account item (such as a password), by means of the invention first receiving a message (for example an email) from a third-party service (such as Google Gmail) which is trying to authenticate an account management change. The system may then intercept that incoming email (from the third-party electronic account provider), and first seek to authenticate (confirm) using the user's own defined authentication process. After the event has been further authenticated (by the user), only then may the account management action (for example password reset) process be continued.

In some embodiments, the system may log, filter, and alert users of incoming account management notifications. In some embodiments, there may exist a direct linkage (for example via a VPN tunnel) from an electronic account provider (for example Google Gmail) to the system, whereby a user's account management messages would go direct (to the system) instead of by means of intercepting the email flow.

In block 160, the system may grant access, to the user, to the content sent by the electronic service (e.g., DropBox or Facebook).

In some embodiments, the system may require confirmation by matching hardware identification information such as the connected device's MAC network address, a mobile phone's IMEI address, an IP address, or any other network address, whether fixed or dynamic, to known, acceptable addresses.

In some embodiments, the system may provide access and control settings that allow users to pre-specify multiple acceptable locations or verification criteria, either for themselves or for others.

In some embodiments, many failed attempts to access or control an account may result in a temporary or permanent account lock, where future attempts to access the account or its notifications may be rejected without some condition being met, whether that condition is additional verification or a set amount of time passing. Many failed attempts to access or control an account or an identified suspicious activity pattern may also trigger actions from the device or server, such as a message sent to an account owner's department head warning of the suspicious activity.

In some embodiments, access and control of all accounts may be centralized in a central control panel enabling management and/or provisioning of multiple accounts and/or logging.

In some embodiments, the system may utilize real-time databases that input data into a likely threat analysis decision tree. One example of a real-time input database may be a geographic list of Hacker hotspot geographic locations. Another example database may be a list of stolen mobile phone identification databases (by phone number, IMEI number, etc.).

In some embodiments, the system may utilize the device's hardware camera to take a picture of the person performing the verification, and the picture may be compared either manually by humans and/or automatically through facial recognition identification.

In some embodiments, the system may utilize the device's data to uniquely identify the user or establish a level of confidence about the user's identity (a “device user data fingerprint”). Device data may include the user's contacts, calendar information, song preferences, etc. as a further means to identify (or likely identify) a user.

In some embodiments, the system may require a user or users to select one of several secret locations, such as a “Secret Clubhouse,” a favorite restaurant, or a favorite donut shop to receive or trigger server or client-side actions/notifications or enable account changes. The location may be specified online without being physically present at the location. Upon specifying that the user would like to set a selected location as a location for future retrieval of messages and/or access to accounts, that location information (such as GPS coordinates, a street address, etc.) may then be optionally hashed with a one-way hashing algorithm and stored in a database for access later.

In some embodiments, the system may involve retrieving/sending and/or encrypting/decrypting messages based on predetermined locations, whether determined by the user or by someone else as a location to send and/or receive messages at. The messages may be decoded or decrypted using a geographic input or other inputs as part or all of the decoding/decryption key, thus making the messages viewable, accessible, or visible only when at one of the known locations or other later matching input.

In some embodiments, the system may require a user or users to select one of several secret locations, such as a “Secret Clubhouse,” a favorite restaurant, or a favorite donut shop to receive or trigger server or client-side actions/notifications or enable account changes. This differs from the previous embodiment in specifying a secret location online; this preferred embodiment requires the user to physically go to the location, specify that they would like to set that current physical location as a secret location (e.g. through a button or other input mechanism that says “I am here”). When specifying that the user would like to set the current location as a location for future retrieval of messages and/or access to accounts, the GPS chip and/or other location-detecting hardware may return location information to software which may perform a one-way or cryptographic hash of the data to be stored in a database or other digital storage for access later.

In some embodiments, the system may involve using multiple location readings or single location readings with reduced accuracy (with accuracy reduced prior to hashing whether on the device or on the server) to increase tolerance in matching as GPS and other location-sensing methods are not always perfect. Thus, multiple readings or reduced accuracy readings may lead to better experiences for the user with more likely matches. Those multiple locations and/or location readings with reduced accuracy (which may be hashed with a one-way hashing function) are all stored for later comparison, and any one of those readings could match the location and/or sub-hashes or sub-locations associated with the primary location that the user considers the location. For instance, a clubhouse may actually represent six different locations in a database (e.g. 20 feet to the North, 20 feet to the South, etc.) to provide strong matching likelihood and a tolerance to a micro-area. The user may also specify multiple locations (e.g. clubhouse, dorm room, restaurant, etc.) which may all have multiple sub-locations as described here.

In some embodiments, one mechanism of Geo-Discovery may involve securing information to be disclosed including pricing information, whether a person won a contest, coupon discounts, etc. For example, a brand may select ten winners among people within a certain location, like winning a prize within a sports stadium.

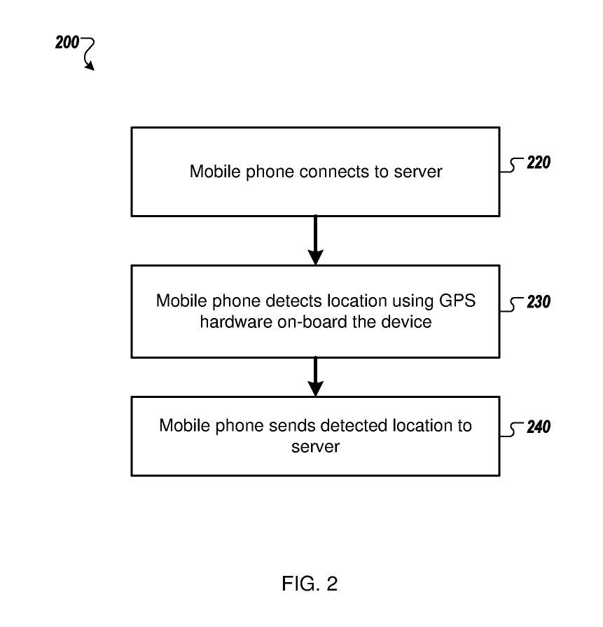

FIG. 2 shows a method whereby a mobile phone is connected to a central server and transmits the location (GPS) of that mobile phone to the central server. In block 220, the user's mobile device connects to a server. For example, the server may be the server described above. The mobile phone may connect to the server using any appropriate communication protocol. Additionally, the mobile may include hardware GPS or other geographic-sensing hardware (such as GPS location, mobile tower identification hardware, etc.).

In block 230, the user's mobile phone may detect location using GPS hardware on-board the device and, in block 240, the user's mobile phone may send detected location to a server. In some embodiments, this location input, taken together with a user-configurable location and/or locations and distances (for example diameters from a location), allow the user to enforce that electronic account changes can only be made from within specified (one or more) geographic locations. This “geographic-restricted account management” step may restrict certain account management changes and/or access to one or more geographic locations.

In some embodiments, the system may offer location-dependent decoding. If a user is present or nearby a pre-determined location as determined by GPS sensors, WiFi networks, cell towers, IP address, or other means, the user can gain access to previously protected materials, including decoding encrypted messages, photos, videos.

In some embodiments, the data representation of the location of the user, such as GPS coordinates or a street address, may be hashed before being stored in a database on the system, preventing anyone who sees the hash or accesses the database from identifying the user's determined secret location(s). A matching hash algorithm may then be performed on the user's location when requesting account access. The hash may be “cryptographically secure,” meaning that it's designed not to expose the original data. In some embodiments, the location to be hashed may be combined with a specific time or time range, a date or dates, weather, or other information to create a unique condition and key(s) by which messages may be decrypted. For example, one might be able to read messages only on a full moon while in a secret location. In some embodiments, the message to be decrypted may be a commercial discount, coupon, or promotional offer that may optionally contain both encrypted and decrypted “open” data. For instance, a restaurant chain might send users a “Discount” message, but to see the discount contained within, users would have to go near or into one of the restaurants to decrypt the contents.

In some embodiments, the location data reported from the device and/or correlated on the server may be confirmed by an external third party, such as requesting confirmation of a user's location from a network carrier's tower or through the network carrier's box information.

In some embodiments, the system may determine whether the device is faking or “spoofing” GPS or other identifying information. This may be accomplished by communicating with a third-party (e.g., a cell tower associated with the user's device) to determine whether the location information provided by the device is in-fact the actual location of the device as determined by the third-party.

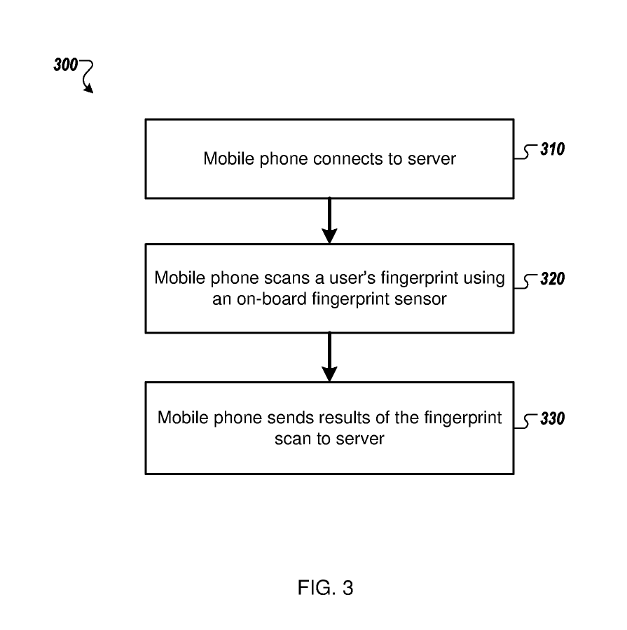

FIG. 3 shows a method whereby a mobile phone is connected to a central server and transmits the results of a fingerprint scan to the central server. In block 310, the mobile phone connects to the server. For example, the server may be the server described above. The mobile phone may connect to the server using any appropriate communication protocol. Additionally, the mobile may include hardware with one or more bio-sensors such as a fingerprint scanner, eye iris scanner, heart rate detector, brain wave detector, speech detector or any other form of hardware capable of measuring, detecting, or identifying any biological traits which could identify an individual.

In block 320, the user's mobile phone may scan a user's fingerprint using an on-board fingerprint sensor and, in block 330, the mobile phone may send results of the fingerprint scan to the server. Accordingly, the user may be able to enforce that electronic account changes can only be made if the fingerprint scan (or other biometric scan) matches what is on record. The authentication of the fingerprint scan can be done either locally at the mobile device or can be performed at the system upon receiving a copy of the fingerprint data from the mobile device.

In some embodiments, the system may require a fingerprint or other biometric identifying data to gain access to an online cloud account (“logging in”). In some embodiments, identifying data is used to gain access to or forward/relay account notifications sent from an external service.

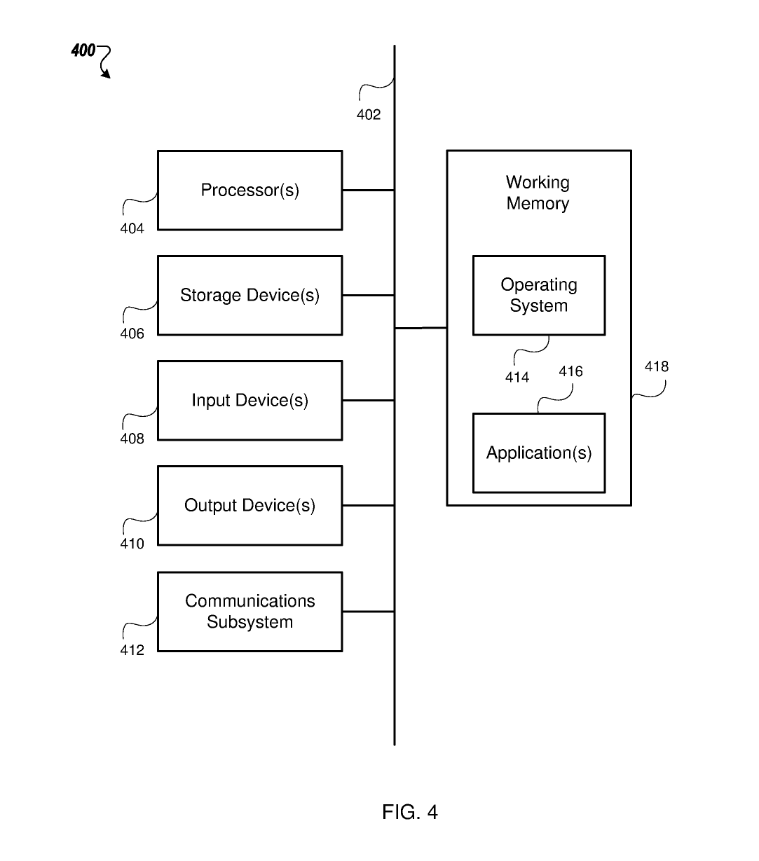

FIG. 4 illustrates an example of a computing system in which one or more embodiments may be implemented. A computer system as illustrated in FIG. 4 may be incorporated as part of the above described system (e.g., the “intermediary” system). For example, computer system 400 can represent some of the components of a computing device, a server, a desktop, a workstation, or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 4 provides a schematic illustration of one implementation of a computer system 400 that can perform the methods provided by various other implementations, as described herein, and/or can function as the host computer system, a remote kiosk/terminal, a point-of-sale device, a telephonic or navigation or multimedia interface in an automobile, a computing device, a set-top box, a table computer and/or a computer system. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 402 (or may otherwise be in communication, as appropriate). The hardware elements may include one or more processors 404, including without limitation one or more general-purpose processors and/or one or more special-purpose processors (such as digital signal processing chips, graphics processing units 422, and/or the like); one or more input devices 408, which can include without limitation one or more cameras, sensors, a mouse, a keyboard, a microphone configured to detect ultrasound or other sounds, and/or the like; and one or more output devices 410, which can include without limitation a display unit such as the device used in implementations of the invention, a printer and/or the like.

In some implementations of the implementations of the invention, various input devices 408 and output devices 410 may be embedded into interfaces such as display devices, tables, floors, walls, and window screens. Furthermore, input devices 408 and output devices 410 coupled to the processors may form multi-dimensional tracking systems.

The computer system 400 may further include (and/or be in communication with) one or more non-transitory storage devices 406, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 400 might also include a communications subsystem 412, which can include without limitation a modem, a network card (wireless or wired), an infrared communication device, a wireless communication device and/or chipset (such as a Bluetooth device, an 802.11 device, a Wi-Fi device, a WiMax device, cellular communication facilities, etc.), and/or the like. The communications subsystem 412 may permit data to be exchanged with a network, other computer systems, and/or any other devices described herein. In many implementations, the computer system 400 will further comprise a non-transitory working memory 418, which can include a RAM or ROM device, as described above. The communications subsystem 412 may be operable to communicate with the account service and the user's mobile device.

The computer system 400 also can comprise software elements, shown as being currently located within the working memory 418, including an operating system 414, device drivers, executable libraries, and/or other code, such as one or more application programs 416, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods, including, for example, the methods described in any of the preceding figures.

A set of these instructions and/or code might be stored on a computer-readable storage medium, such as the storage device(s) 406 described above. In some cases, the storage medium might be incorporated within a computer system, such as computer system 400. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 400 may be omitted or may be implemented separate from the illustrated system. For example, the processor 404 and/or other elements may be implemented separate from the input device 408. In one implementation, the processor may be configured to receive images from one or more cameras that are separately implemented. In some implementations, elements in addition to those illustrated in FIG. 4 may be included in the computer system 400.

Some implementations may employ a computer system (such as the computer system 400) to perform methods in accordance with the disclosure. For example, some or all of the procedures of the described methods may be performed by the computer system 400 in response to processor 404 executing one or more sequences of one or more instructions (which might be incorporated into the operating system 414 and/or other code, such as an application program 416) contained in the working memory 418. Such instructions may be read into the working memory 418 from another computer-readable medium, such as one or more of the storage device(s) 406. Merely by way of example, execution of the sequences of instructions contained in the working memory 418 might cause the processor(s) 404 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 400, various computer-readable media might be involved in providing instructions/code to processor(s) 404 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 406. Volatile media include, without limitation, dynamic memory, such as the working memory 418. Transmission media include, without limitation, coaxial cables, copper wire and fiber optics, including the wires that comprise the bus 402, as well as the various components of the communications subsystem 412 (and/or the media by which the communications subsystem 412 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 404 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various implementations of the invention.

The communications subsystem 412 (and/or components thereof) generally will receive the signals, and the bus 402 then might carry the signals (and/or the data, instructions, etc. carried by the signals) to the working memory 418, from which the processor(s) 404 retrieves and executes the instructions. The instructions received by the working memory 418 may optionally be stored on a non-transitory storage device 406 either before or after execution by the processor(s) 404.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer program product, stored on a non-transitory computer readable medium, comprising instructions that when executed on one or more computers cause the one or more computers to perform operations implementing an authorization service controlling access to an electronic account belonging to a user, the operations comprising:
receiving, by the authorization service, an authorization service request for access to the electronic account belonging to the user;
sending, from the authorization service, an authorization request to a client device associated with the user;
in response to receiving, from the client device, a response from the user to the authorization request,
authenticating the user based at least in part on the received response to the authorization request; and
in an instance in which the user is authenticated, granting the user access to the electronic account.

2. The computer program product of claim 1, wherein a provider of the electronic account belonging to the user is one or more of an e-mail account provider, file management account provider, social media account provider, financial account provider, business-related account provider, hardware management account provider, home security account provider, smart home account provider, game account provider, entertainment account provider, communication account provider, travel account provider, retail account provider, legal account provider, or food ordering account provider.

3. The computer program product of claim 1, wherein the client device is a mobile device registered to the user.

4. The computer program product of claim 3, wherein the authorization request comprises a request for a location of the mobile device.

5. The computer program product of claim 1, wherein the authorization request comprises a request for a password.

6. The computer program product of claim 1, wherein:
the authorization request comprises a request for a fingerprint scan; and
the response to the authorization request comprises fingerprint data obtained from a fingerprint scan performed on the user's finger.

7. The computer program product of claim 1, wherein the authorization request is sent to a unique e-mail address associated with the user.

8. A system comprising:
one or more computers and one or more storage devices storing instructions that are operable, when executed by the one or more computers, to cause the one or more computers to perform operations implementing an authorization service controlling access to an electronic account belonging to a user, the operations comprising:
receiving, by the authorization service, an authorization service request for access to the electronic account belonging to the user;
sending, from the authorization service, an authorization request to a client device associated with the user;
in response to receiving, from the client device, a response from the user to the authorization request,
authenticating the user based at least in part on the received response to the authorization request; and
in an instance in which the user is authenticated, granting the user access to the electronic account.
